(19) United States
(12) Patent Application Publication
(10) Pub. No.: US 2026/0106873 A1
(43) Pub. Date: Apr. 16, 2026

(54) SYSTEM AND METHOD OF OPERATING THE SAME

(71) Applicant: LG ELECTRONICS INC., Seoul (KR)

(72) Inventors: Minjae CHOI, Seoul (KR); Jinuk LEE, Seoul (KR); Hyojin KIM, Seoul (KR); Changhyeon HONG, Seoul (KR); Suyeong WON, Seoul (KR)

(73) Assignee: LG ELECTRONICS INC., Seoul (KR)

(21) Appl. No.: 19/358,742

(22) Filed: Oct. 15, 2025

(30) Foreign Application Priority Data
Oct. 15, 2024 (KR) 10-2024-0139941
Sep. 1, 2025 (WO) PCT/KR2025/013377

(51) Int. Cl. H04L 9/40

(52) U.S. Cl. CPC H04L 63/101

(57) ABSTRACT

The present disclosure relates to a system and a method of operating the same. The system according to an embodiment of the present disclosure includes a home appliance, a plurality of user terminals, and at least one server, wherein a first user terminal is configured to obtain a user list corresponding to a specific application from the at least one server and to transmit data about a user selected from the user list to the at least one server, wherein the at least one server is configured to set control authority over the home appliance for the selected user based on the data about the selected user which is received from the first user terminal, and to process a control command received from a second user terminal, corresponding to the selected user, by using the specific application based on the control authority set for the selected user.

### CROSS-REFERENCE TO RELATED APPLICATION

Pursuant to 35 U.S.C. § 119, this application claims the benefit of earlier filing date and right of priority to Korean Application No. 10-2024-0139941, filed on Oct. 15, 2024, and International Application No. PCT/KR2025/013377, filed on Sep. 1, 2025, the contents of which are all incorporated by reference herein in their entirety.

### BACKGROUND OF THE INVENTION

### 1. Field of the Invention

This disclosure relates to a system and a method of operating the same, and more particularly to a system for controlling a home appliance by using a user terminal, and a method of operating the system.

### 2. Discussion of the Related Art

Recently, with the development of digital technology, various types of electronic devices, such as mobile communication terminals, smartphones, tablet personal computers (PCs), electronic organizers, notebooks, personal digital assistants (PDAs), or wearable devices have been widely used.

The electronic device is implemented in the form of a multimedia player having multiple functions. For example, the electronic device may provide a call function such as a voice call, a video call, etc., a message transmission/reception function such as a short message service (SMS)/multimedia message service (MMS), an e-mail, etc., a wireless (e.g., Bluetooth, wireless fidelity (Wi-Fi), etc.) communication function, a photographing function, a broadcast playback function, a video playback function, a music playback function, an Internet function, a messenger function, a game function, a Social Networking Service (SNS) function, or the like.

Home appliances are devices used for user convenience. The home appliances, such as display devices, air conditioners, washing machines, refrigerators, etc., which are used in specific spaces at home or office, perform their unique functions and operations according to a user's operation. For example, the display device, such as a TV, a monitor, or a projector, has the function of displaying images viewed by a user, and the user may view broadcast programs using the display device.

Recently, as smart home environments have become widespread, technologies for controlling various home appliances using user terminals are being widely used. For example, by using user terminals such as smartphones, users can remotely control the operation of home lighting, refrigerators, washing machines, TVs, etc., or check their status.

A plurality of users generally live in a given space where home appliances are located, and the respective users often want to control the same home appliance. In addition, there may also be cases where other users who do not live in the given space want to remotely control home appliances for the users living in the space.

As described above, in order to allow the home appliances to be remotely controlled by each of the plurality of users, user terminals need to be individually linked with home appliances, or a procedure for separately granting control authority to each user is required. This procedure requires repetitive operations for each user, thereby causing user inconvenience in terms of usability. Accordingly, there is a need for a technical solution to enable various users to control home appliances in a simple and convenient manner.

### SUMMARY OF THE INVENTION

It is an objective of the present disclosure to solve the above and other problems.

It is another objective of the present disclosure to provide a system capable of setting control authority over a home appliance for at least one user in a simple and convenient manner, and a method of operating the system.

It is yet another objective of the present disclosure to provide a system capable of setting control authority over a home appliance individually for each user, and a method of operating the system.

It is yet another objective of the present disclosure to provide a system capable of setting various functions of a home appliance that are available to users, and a method of operating the system.

It is yet another objective of the present disclosure to provide a system capable of setting various times during which users are allowed to use functions of a home appliance, and a method of operating the system.

It is yet another objective of the present disclosure to provide a system capable of providing a service associated with controlling a home appliance by using a specific application corresponding to a service for supporting communication between users, and a method of operating the system.

In accordance with an aspect of the present disclosure, the above and other objectives can be accomplished by providing a system including a home appliance, a plurality of user terminals, and at least one server, wherein a first user terminal is configured to obtain a user list corresponding to a specific application from the at least one server and to transmit data about a user selected from the user list to the at least one server, wherein the at least one server is configured to set control authority over the home appliance for the selected user based on the data about the selected user which is received from the first user terminal, and to process a control command received from a second user terminal, corresponding to the selected user, by using the specific application based on the control authority set for the selected user.

In accordance with another aspect of the present disclosure, the above and other objectives can be accomplished by providing a method of operating a system including at least one server, the method including: by the at least one server, providing a user list corresponding to a specific application to a home appliance; by the at least one server, receiving, from the home appliance, data about a user selected from the user list; by the at least one server, setting control authority over the home appliance for the selected user based on the data about the selected user which is received from a first user terminal; and by the at least one server, processing a control command received from a second user terminal, corresponding to the selected user, by using the specific application based on the control authority set for the selected user.

According to at least one of the embodiments of the present disclosure, control authority over a home appliance may be set for at least one user in a simple and convenient manner.

According to at least one of the embodiments of the present disclosure, control authority over a home appliance may be set individually for each user.

According to at least one of the embodiments of the present disclosure, it is possible to set various functions of a home appliance that are available to users.

According to at least one of the embodiments of the present disclosure, it is possible to set various times during which users are allowed to use functions of a home appliance.

According to at least one of the embodiments of the present disclosure, a service associated with controlling a home appliance may be provided by using a specific application corresponding to a service for supporting communication between users.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### BRIEF DESCRIPTION OF THE DRAWINGS

FIG. 1 is a block diagram illustrating a home appliance according to an embodiment of the present disclosure.

FIG. 2 is a block diagram illustrating a server according to an embodiment of the present disclosure.

FIG. 3 is an exemplary diagram illustrating a configuration of a system according to an embodiment of the present disclosure.

FIGS. 4A and 4B are flowcharts referred to in the description of operation of a system for setting control authority over a home appliance, according to an embodiment of the present disclosure.

FIGS. 5 to 20 are diagrams referred to in the description of setting control authority over a home appliance, according to an embodiment of the present disclosure.

FIG. 21 is a flowchart referred to in the description of operation of a system for changing control authority over a home appliance, according to an embodiment of the present disclosure.

FIGS. 22 and 23 are diagrams referred to in the description of a change in control authority over a home appliance, according to an embodiment of the present disclosure.

FIGS. 24 and 25 are flowcharts referred to in the description of operation of a system for controlling a home appliance, according to an embodiment of the present disclosure.

### DETAILED DESCRIPTION OF THE PREFERRED EMBODIMENTS

Hereinafter, the present disclosure will be described in detail with reference to the attached drawings. In the drawings, parts not related to description are omitted in order to clearly and briefly describe the present disclosure, and identical or extremely similar parts are denoted by the same reference numerals throughout the specification.

The suffixes “module” and “part” for components used in the following description are simply given in consideration of the ease of writing this specification and do not have any particularly important meaning or role. Accordingly, the terms “module” and “part” may be used interchangeably.

In the present disclosure, it will be further understood that the term “comprise” or “include” specifies the presence of a stated feature, figure, step, operation, component, part or combination thereof, but does not preclude the presence or addition of one or more other features, figures, steps, operations, components, or combinations thereof.

Further, in this specification, the terms “first” and/or “second” are used to describe various components, but such components are not limited by these terms. The terms are used to discriminate one component from another component.

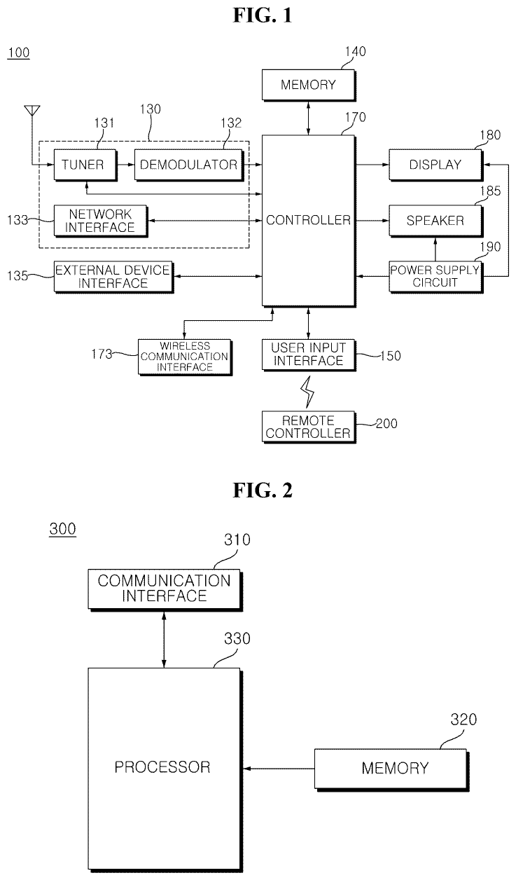

FIG. 1 is a block diagram showing a configuration of a home appliance according to an embodiment of the present disclosure.

Referring to FIG. 1, a home appliance 100 may include an image receiver 130, an external device interface 135, a memory 140, a user input interface 150, a controller 170, a wireless communication interface 173, a display 180, a speaker 185, and a power supply circuit 190.

The image receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the home appliance 100 and an external device. The external device interface 135 may receive one or more of images and audio output from an external device connected to the home appliance 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The external device interface 135 may receive an application or a list of applications in an external device adjacent thereto, and transmit the same to the controller 170 or the memory 140.

The external device connectable to the external device interface 135 may be any one of a set-top box, a Blu-ray player, a DVD player, a game machine, a sound bar, a smartphone, a PC, a USB memory, and a home theater, but this is only an example.

The network interface 133 may provide an interface for connecting the home appliance 100 to a wired/wireless network including an Internet network. The network interface 133 may transmit or receive data to or from other users or other electronic devices through a connected network or another network linked to the connected network.

In addition, a part of content data stored in the home appliance 100 may be transmitted to a selected user among a selected user or a selected electronic device among other users or other electronic devices registered in advance in the home appliance 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a content provider or a network operator. That is, the network interface 133 may receive content such as movies, advertisements, games, VOD, and broadcast signals and information related thereto provided from a content provider or a network provider through a network.

In addition, the network interface 133 may receive update information and update files of firmware provided by the network operator, and may transmit data to an Internet or content provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The home appliance 100 may play back a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the home appliance 100.

In addition, the controller 170 may control the home appliance 100 by a user command input through the user input interface 150 or an internal program and connect to a network to download an application a list of applications or applications desired by the user to the home appliance 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing back an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface unit or an image which is stored in the memory 140 to be displayed on the display 180. In this case, an image being displayed on the display 180 may be a still image or a moving image, and may be a 2D image or a 3D image.

In addition, the controller 170 may allow content stored in the home appliance 100, received broadcast content, or external input content input from the outside to be played back, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the home appliance 100 and a wireless communication system, between the home appliance 100 and another home appliance 100, or between the home appliance 100 and a network in which the home appliance 100 (or an external server) is located through wireless area networks. The wireless area networks may be wireless personal area networks.

Here, the another home appliance 100 may be a wearable device (e.g., a smartwatch, smart glasses or a head mounted display (HMD), a mobile terminal such as a smart phone, which is able to exchange data (or interwork) with the home appliance 100 according to the present disclosure. The wireless communication interface 173 may detect (or recognize) a wearable device capable of communication around the home appliance 100.

Furthermore, when the detected wearable device is an authenticated device to communicate with the home appliance 100 according to the present disclosure, the controller 170 may transmit at least a portion of data processed by the home appliance 100 to the wearable device through the wireless communication interface 173. Therefore, a user of the wearable device may use data processed by the home appliance 100 through the wearable device.

The display 180 may convert image signals, data signals, and OSD signals processed by the controller 170, or image signals or data signals received from the external device interface 135 into R, G, and B signals, and generate drive signals.

Meanwhile, since the home appliance 100 shown in FIG. 1 is only an embodiment of the present disclosure, some of the illustrated components may be integrated, added, or omitted depending on the specification of the home appliance 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the home appliance 100 shown in FIG. 1, the home appliance 100 may receive an image through the network interface 133 or the external device interface 135 without a tuner 131 and a demodulator 132 and play back the same.

For example, the home appliance 100 may be divided into an image processing device, such as a set-top box, for receiving broadcast signals or content according to various network services, and a content playback device that plays back content input from the image processing device.

In this case, an operation method of the home appliance according to an embodiment of the present disclosure will be described below may be implemented by not only a display device as described with reference to FIG. 1 and but also one of an image processing device such as the separated set-top box and a content playback device including the display 180 the speaker 185.

In the present disclosure, the home appliance 100 is exemplarily described as a display device, but is not limited thereto. For example, the home appliance 100 may include an air conditioner, a refrigerator, an air purifier, a washing machine, and the like.

FIG. 2 is a block diagram illustrating a server according to an embodiment of the present disclosure.

Referring to FIG. 2, the server 300 may include a communication interface 310, a memory 320, and/or a processor 330.

The communication interface 310 may include at least one communication module for connection with a network. The communication interface 310 may access the network and communicate with the home appliance 100.

The memory 320 may store a program for processing and controlling each signal within the processor 330, or may store a signal-processed data signal. For example, the memory 320 may store application programs designed for the purpose of performing various tasks that can be processed by the processor 330, and may selectively provide some of the stored application programs when requested by the processor 330. The programs stored in the memory 320 are not particularly limited as long as they can be executed by the processor 330.

The memory 320 of FIG. 2 is provided separately from the processor 330, but the scope of the present disclosure is not limited thereto, and the memory 320 may be included in the processor 330.

The memory 320 may include at least one of volatile memory (e.g., DRAM, SRAM, SDRAM, etc.) and nonvolatile memory (e.g., flash memory, hard disk drive (HDD), solid-state drive (SSD), etc.).

The memory 320 may also store data learned through machine learning such as deep learning, models, algorithms, etc.

The memory 320 may store a database. The database may be composed of data about a user, data about the home appliance 100, etc.

The processor 330 may be connected to each component provided in the server 300, and may control the overall operation of each component. The processor 330 may transmit and receive data to and from each component provided in the server 300.

The processor 330 may transmit and receive various signals containing data to and from devices such as the home appliance 100, through the communication interface 310.

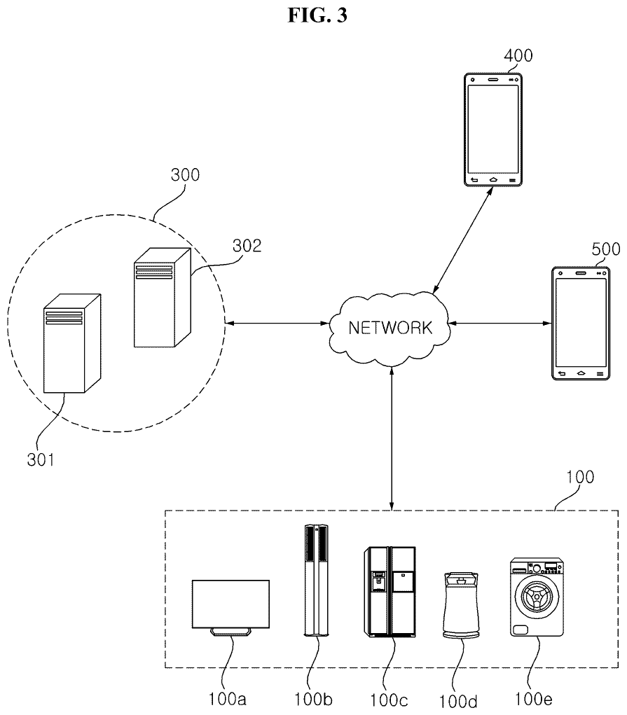

FIG. 3 is an exemplary diagram illustrating a configuration of a system according to an embodiment of the present disclosure.

Referring to FIG. 3, a system 10 may include a home appliance 100, a server 300, and a plurality of user terminals 400 and 500.

The home appliance 100 may include a display device 100a, an air conditioner 100b, a refrigerator 100c, an air cleaner 100d, a washing machine 100e, and the like.

The home appliance 100 may communicate with the server 300. For example, the home appliance 100 may exchange data with the server 300 via a network, such as the Internet.

The home appliance 100 may communicate with the user terminals 400 and 500. For example, the home appliance 100 and the user terminals 400 and 500 may communicate with each other using a short-range communication method. For example, the home appliance 100 and the user terminals 400 and 500 may communicate with each other via a relay device, i.e., a local area network provided by an access point (AP).

The server 300 may include a first server 301 corresponding to the home appliance 100 and/or a second server 302 corresponding to a specific application. The first server 301 and the second server 302 may exchange data with each other. Here, the specific application may be an application corresponding to a service, such as a messenger, a Social Networking Service (SNS), or the like, which supports communication between users.

In the present disclosure, an example of the server 300 including two servers 301 and 302 is illustrated, but the server 300 is not limited thereto. For example, the server 300 may be composed of a single server or three or more servers.

According to various embodiments of the present disclosure, at least some of the operations performed by the first server 301 may be performed by the second server 302. According to various embodiments of the present disclosure, at least some of the operations performed by the second server 302 may be performed by the first server 301.

The first server 301 may store data associated with the home appliance 100. For example, the first server 301 may store an identifier of the home appliance 100, functions of the home appliance 100, information about a specific user for whom control authority is set, control authority set for a specific user, terms of use of a service by a specific user, etc.

The second server 302 may store data about a specific application. For example, the second server 302 may store user information (e.g., user account) of a specific user using a specific application, a list of other users mapped to the specific user (hereinafter referred to as a user list), messages transmitted between users, terms of use of a service by a specific user, etc.

The user terminals 400 and 500 may obtain data for access to a specific application (hereinafter referred to as App access information). For example, the App access information may include a Uniform Resource Locator (URL), a deep link, and the like corresponding to a specific application. The following description will be made based on the deep link.

According to an embodiment of the disclosure, the user terminals 400 and 500 may obtain App access information by using the home appliance 100. For example, the user terminals 400 and 500 may obtain the App access information from the home appliance 100 using a short-range communication method. For example, the user terminals 400 and 500 may obtain the App access information based on an object corresponding to the App access information, which is output through a display 180 of the home appliance 100.

The user terminals 400 and 500 may access a specific application based on the App access information. For example, the user terminals 400 and 500 may output a web view corresponding to a specific application through displays of the user terminals 400 and 500, by using a deep link included in the App access information. In this case, the user terminals 400 and 500 may exchange data with the second server 302 by using the web view.

The user terminals 400 and 500 may control the home appliance 100. For example, the server 400 may set control authority over the home appliance 100 for users corresponding to the user terminals 400 and 500. In this case, the server 300 may control the home appliance 100 based on control commands received from the user terminals 400 and 500 corresponding to users for whom the control authority is set. Here, the control command may include information about the home appliance 100 to be controlled, functions of the home appliance 100, and the like.

According to an embodiment of the disclosure, the user terminals 400 and 500 may control the home appliance 100 by using a specific application. For example, the user terminals 400 and 500 may transmit control commands to the second server 302 by using a specific application. The second server 302 may transfer the control commands, received from the user terminals 400 and 500, to the first server 301. In this case, the second server 302 may transmit, to the first server 301, information about the users corresponding to the user terminals 400 and 500 transmitting the control commands.

The user terminals 400 and 500 may output control authority over the home appliance 100 that is set for the users corresponding to the user terminals 400 and 500. For example, the user terminals 400 and 500 may request the server 300 to transmit the control authority set for the users corresponding to the user terminals 400 and 500. In this case, the user terminals 400 and 500 may receive the control authority from the server 300 and output a message regarding the control authority set for the users corresponding to the user terminals 400 and 500.

The user terminals 400 and 500 may output the control authority over the home appliance 100 that is set for the users corresponding to the user terminals 400 and 500, by using a specific application. For example, the user terminals 400 and 500 may request the server 300 to transmit the control authority set for the users corresponding to the user terminals 400 and 500, by using a specific application. In this case, the user terminals 400 and 500 may receive the control authority from the server 300 and output a message regarding the control authority set for the users corresponding to the user terminals 400 and 500, by using a specific application.

The first server 301 may process the control command received from the second server 302. For example, the first server 301 may check whether the control authority over the home appliance 100 is set for the users corresponding to the user terminals 400 and 500, based on information about the users corresponding to the user terminals 400 and 500 which is received from the second server 302. In this case, if the control authority over the home appliance 100 is set for the users corresponding to the user terminals 400 and 500, the first server 301 may process the control command received from the second server 302 based on the set control authority.

The server 300 may determine whether there is at least one user for whom the control authority over the home appliance 100 is set.

The server 300 may determine the number of new users for whom the control authority over the home appliance 100 can be set. For example, the server 300 may compare the number of users, for whom the control authority is pre-set (hereinafter referred to as existing users), with a maximum number of users (e.g., five) for whom the control authority can be set, and may determine the number of new users for whom the control authority can be set.

The server 300 may determine, as a representative user, a user among at least one user for whom the control authority over the home appliance 100 is set. Here, the representative user may add, change, and/or delete the control authority over the home appliance 100 which is set for users.

According to an embodiment of the disclosure, if the control authority for the representative user is released, the server 300 may release the control authority for all users for whom the control authority over the home appliance 100 is set.

According to an embodiment of the disclosure, the user terminals 400 and 500 may request the home appliance 100 and/or a user terminal, corresponding to the representative user, to change the control authority set for the users corresponding to the user terminals 400 and 500. For example, the user terminals 400 and 500 may transmit, to the server 300, a request for changing the control authority set for the users corresponding to the user terminals 400 and 500, by using a specific application. In this case, the server 300 may transmit the request for changing the control authority set for the users corresponding to the user terminals 400 and 500 to the home appliance 100 and/or the user terminal corresponding to the representative user.

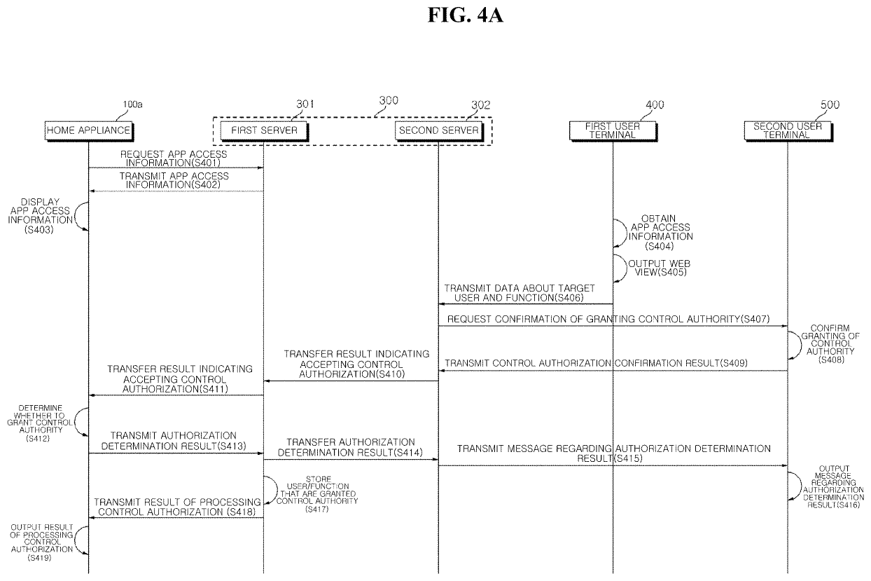

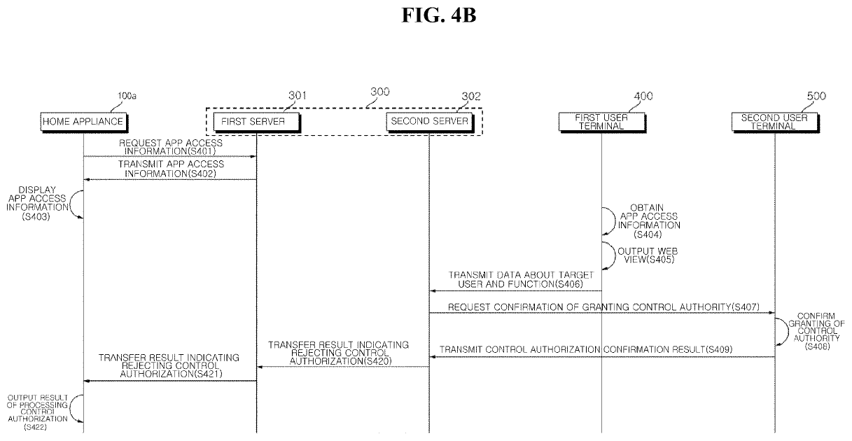

FIGS. 4A and 4B are flowcharts referred to in the description of operation of a system for setting control authority over a home appliance, according to an embodiment of the present disclosure.

Referring to FIG. 4A, the home appliance 100 may request the first server 301 to provide App access information for access to a specific application in operation S401.

In response to the request received from the home appliance 100, the first server 301 may transmit the App access information to the home appliance 100 in operation S402. For example, the first server 301 may transmit the App access information, including a deep link corresponding to the specific application, to the home appliance 100.

According to an embodiment of the disclosure, the home appliance 100 may transmit a request for transmitting App access information, including an identifier of the home appliance 100, to the first server 301. For example, the identifier of the home appliance 100 may include a universally unique identifier (UUID), a serial number, a Media Access Control (MAC), and the like.

The first server 301 may transmit the App access information, corresponding to the identifier of the home appliance 100, to the home appliance 100. For example, the App access information corresponding to the identifier of the home appliance 100 may include a deep link associated with setting the control authority over the home appliance 100.

According to an embodiment of the disclosure, the App access information may include a time during which access to a specific application is allowed (hereinafter referred to as an effective time). That is, the access to the specific application using the App access information transmitted to the home appliance 100 may be allowed within the effective time.

The first server 301 may transfer the effective time to the second server 302. In this case, the second server 302 may determine whether to allow the access to the specific application using the App access information transmitted to the home appliance 100, based on whether the access to the specific application using the App access information transmitted to the home appliance 100 satisfies the effective time.

The home appliance 100 may output the App access information in operation S403. For example, the home appliance 100 may display an object, corresponding to the App access information, through the display 180. In this case, the object may be an image (e.g., QR code) corresponding to a deep link included in the App access information.

According to an embodiment of the disclosure, if the App access information includes the effective time, the home appliance 100 may output the object corresponding to the App access information based on the effective time. For example, the home appliance 100 may output the object corresponding to the App access information during the effective time. For example, the home appliance 100 may output the effective time, along with the object corresponding to the App access information, through the display 180.

A first user terminal 400 may obtain the App access information in operation S404. For example, the first user terminal 400 may obtain the App access information from the object captured by a camera of the first user terminal 400 and displayed through the display 180 of the home appliance 100.

The first user terminal 400 may output a web view, corresponding to a specific application, based on the App access information in operation S405. Here, the web view output through the first user terminal 400 may be a web view associated with setting the control authority over the home appliance 100 by using the specific application.

If a specific application is not installed in the first user terminal 400, the first user terminal 400 may perform an operation for installing the specific application in response to obtaining the App access information. The first user terminal 400 may output a web view, corresponding to the specific application, in response to obtaining the App access information when the specific application is installed in the first user terminal 400.

The first user terminal 400 may transmit, to the second server 302, data about a user for whom the control authority over the home appliance 100 is to be set (hereinafter referred to as a target user) in operation S406. Here, the data about the target user may include at least target user information (e.g., user account) for use in the specific application.

For example, a user of the first user terminal 400 (hereinafter referred to as a first user) may input target user information by using a web view output through the first user terminal 400. In this case, the first user terminal 400 may transmit data about the target user to the second server 302 based on the target user information input by the first user.

For example, the second server 302 may transmit, to the first user terminal 400, a user list corresponding to the specific application for the first user. The first user terminal 400 may output the user list through a web view. The first user may select a target user from the user list by using the web view output through the first user terminal 400. In this case, the first user terminal 400 may transfer data about the target user, selected from the user list, to the second server 302.

According to an embodiment of the disclosure, the data about the target user may include a function of the home appliance 100 that is available to the target user. For example, the first user may select a function of the home appliance 100 that is available to the target user, by using the web view output through the first user terminal 400. In this case, if there are a plurality of target users, the first user may select, for each of the plurality of target users, functions of the home appliance 100 that are available to the target users.

According to an embodiment of the disclosure, the data about the target user may include a time during which the target user is allowed to use a function of the home appliance 100. For example, the first user may select a time during which the target user is allowed to use a function of the home appliance 100, by using the web view output through the first user terminal 400. In this case, if a plurality of functions of the home appliance 100 are available to the target user, the first user may select, for each of the functions of the home appliance 100, a time during which the target user is allowed to use the functions of the home appliance 100.

The second server 302 may transmit a message, requesting confirmation of granting the control authority, to a second user terminal 500 corresponding to a second user as the target user based on the data about the target user that is received from the first user terminal 400 in operation S407. For example, the second server 302 may transmit the message, requesting confirmation of granting the control authority, to the second user terminal 500 by using a specific application. In this case, the message requesting confirmation of granting the control authority may include the function of the home appliance 100 that is available to the second user.

The second user terminal 500 may output the message requesting confirmation of granting the control authority in operation S408. For example, the second user terminal 500 may output the message requesting confirmation of granting the control authority, by using the specific application.

A user of the second user terminal 500 may select to accept or reject the granted control authority. For example, the second user may select to accept or reject the granted control authority by using a specific application.

The second user terminal 500 may transmit a result of the confirmation of granting the control authority (hereinafter referred to as a control authorization confirmation result) to the second server 302 in operation S409. For example, the second user terminal 500 may transmit data, corresponding to accepting or rejecting control authorization which is selected by the second user, to the second server 302 by using a specific application.

The second server 302 may transfer, to the first server 301, the control authorization confirmation result received from the second user terminal 500 in operation S410. For example, the second server 302 may transfer data indicative of accepting control authorization, which is received from the second user terminal 500, to the first server 301.

According to an embodiment of the disclosure, if the control authorization confirmation result, which is received from the second user terminal 500, indicates accepting control authorization, the second server 302 may transmit, to the first server 301, data required for setting the control authority for the second user. For example, the data required for setting the control authority for the second user may include second user information, functions of the home appliance 100 that are available to the second user, a time during which the second user is allowed to use the functions of the home appliance 100 that are available to the second user, and the like.

The first server 301 may transfer the control authorization confirmation result, received from the second server 302, to the home appliance 100 in operation S411.

In response to receiving, from the first server 301, data corresponding to accepting control authorization for the second user, the home appliance 100 may determine whether to grant the control authority to the second user in operation S412. For example, the home appliance 100 may output a user interface for determining whether to grant the control authority to the second user through the display 180. In this case, the first user may select either to approve or deny control authorization for the second user, by using the user interface output through the display 180.

The home appliance 100 may transmit, to the first server 301, a result of determining whether to grant the control authority to the second user (hereinafter referred to an authorization determination result) in operation S413. For example, the first user terminal 400 may transmit, to the first server 310, data corresponding to approving or denying control authorization for the second user which is selected by the first user.

The first server 301 may transfer the authorization determination result, received from the home appliance 100, to the second server 302 in operation S414.

The second server 302 may transmit a message regarding the authorization determination result, received from the first server 301, to the second user terminal 500 in operation S415. For example, the second server 302 may transmit the message regarding the authorization determination result to the second user terminal 500 by using a specific application. In addition, the second server 302 may also transmit the message regarding the authorization determination result to the first user terminal 400 by using a specific application.

The second user terminal 500 may output the message regarding the authorization determination result in operation S416. For example, the second user terminal 500 may output the message regarding the authorization determination result by using a specific application.

If the authorization determination result received from the home appliance 100 indicates approving control authorization for the second user, the first server 301 may set the control authority over the home appliance 100 for the second user in operation S417. For example, the first server 301 may store information about the second user, functions of the home appliance 100 that are available to the second user, a time during which the second user is allowed to use the functions of the home appliance 100 that are available to the second user, etc., based on the data received from the second server 302.

The first server 301 may transmit, to the home appliance 100, a result of processing the control authorization for the second user in operation S418. For example, the first server 301 may notify the home appliance 100 that the process of setting the control authority for the second user is completed.

The home appliance 100 may output the result of processing the control authorization for the second user in operation S419. For example, the home appliance 100 may output a screen corresponding to completing the process of setting the control authority for the second user through the display 180.

Referring to FIG. 4B, the home appliance 100 may transfer the control authorization confirmation result, received from the second user terminal 500, to the first server 301 in operation S420. For example, the second server 302 may transfer, to the first server 301, data indicative of rejecting the control authorization which is received from the second user terminal 500.

According to an embodiment of the disclosure, if the control authorization confirmation result received from the second user terminal 500 indicates rejecting the control authorization, the second server 302 may omit the process of transmitting data required for setting the control authority for the second user.

If the control authorization confirmation result received from the second user terminal 500 indicates rejecting the control authorization, the second server 302 may also transmit a message, indicating that the second user rejects the control authorization, to the first user terminal 400 by using a specific application.

The first server 301 may transfer the control authorization confirmation result, received from the second server 302, to the home appliance 100 in operation S421.

The home appliance 100 may output a result of processing the control authorization for the second user in operation S422. For example, if the control authorization confirmation result received from the first server 301 indicates rejecting the control authorization, the home appliance 100 may output a screen corresponding to rejecting, by the second user, the control authorization through the display 180.

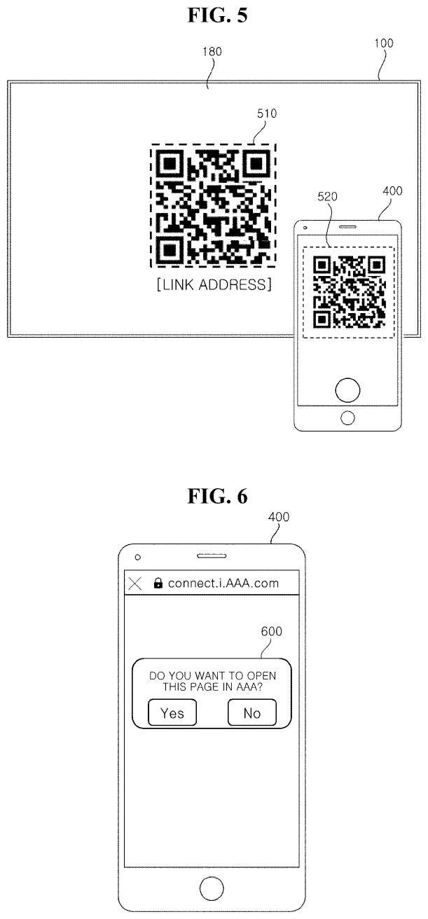

FIGS. 5 to 20 are diagrams referred to in the description of setting control authority over a home appliance, according to an embodiment of the present disclosure.

According to various embodiments of the present disclosure, at least some of the processes of setting the control authority over the home appliance 100 may be omitted. In addition, according to various embodiments of the present disclosure, the operation performed by the server 300 can be construed as being performed by at least one of the first server 301 and the second server 302.

Referring to FIG. 5, the home appliance 100 may output an object 510 corresponding to App access information through the display 180.

The first user terminal 400 may obtain the App access information from an image 520 of the object 510 that is captured by a camera of the first user terminal 400. The first user terminal 400 may access a specific application based on the obtained App access information.

Referring to FIGS. 6 to 10, the first user terminal 400 may output a web view corresponding to the specific application, based on the App access information. The web view corresponding to the specific application may be output based on data transmitted by the second server 320.

Referring to FIG. 6, a screen including a user interface (hereinafter referred to as a UI) 600 for checking access to a specific application associated with setting of the control authority over the home appliance 100 may be output through the first user terminal 400. The first user may select whether to access the specific application by using the UI 600.

According to an embodiment of the disclosure, if it is impossible to set the control authority over the home appliance 100, a web view corresponding to the state in which it is impossible to set the control authority over the home appliance 100 may be output through the first user terminal 400. For example, if the home appliance 100 is turned off, the server 300 may control a web view, corresponding to the state in which it is impossible to set the control authority over the home appliance 100, to be output through the first user terminal 400. For example, if the process of setting the control authority performed in the home appliance 100 is terminated, the server 300 may control a web view, corresponding to the state in which it is impossible to set the control authority over the home appliance 100, to be output through the first user terminal 400.

According to an embodiment of the disclosure, if it is impossible to set the control authority over the home appliance 100 for a first user, a web view corresponding to the state in which it is impossible to set the control authority over the home appliance 100 may be output through the first user terminal 400. If the first user is under an age limit (e.g., 14 years old), the server 300 may control a web view, corresponding to the state in which it is impossible to set the control authority over the home appliance 100 for the first user, to be output through the first user terminal 400.

According to an embodiment of the disclosure, if it is impossible to set the control authority over the home appliance 100 for a new user, a web view corresponding to the state in which it is impossible to set the control authority over the home appliance 100 may be output through the first user terminal 400. For example, if the number of existing users, for whom the control authority over the home appliance 100 is pre-set, corresponds to a maximum number of users (e.g., five) for whom the control authority can be set, the server 300 may control a web view, corresponding to the state in which it is impossible to set the control authority over the home appliance 100, to be output through the first user terminal 400.

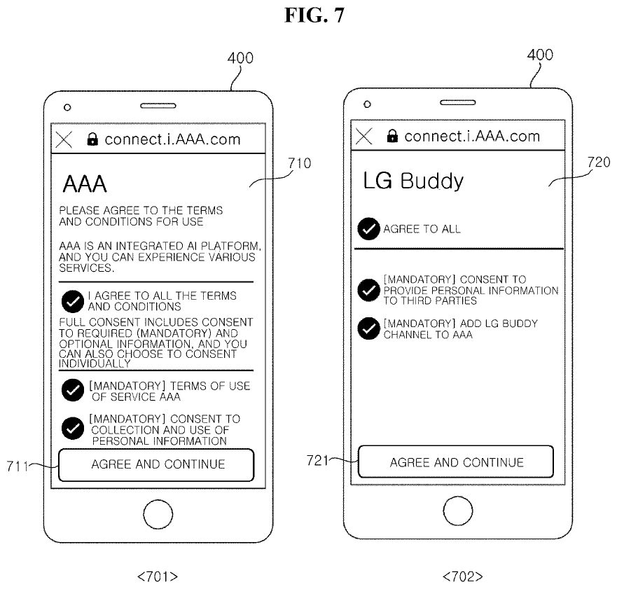

Referring to FIG. 7, at least one screen displaying the terms of use of a service that controls the home appliance 100 by using a specific application may be output through the first user terminal 400. The first user may agree to at least one terms of use by using the UI displayed on the screen output by the first user terminal 400.

For example, a first terms of use screen 710, displaying first terms of use of a specific application for controlling the home appliance 100 may be output through the first user terminal 400 (701). A user may agree to the first terms of use by using a UI 711 displayed on the first terms of use screen 710. Data about the first terms of use agreed by the user may be stored in the server 300.

For example, a second terms of use screen 720, displaying second terms of use regarding provision of first user information used in a specific application to third parties, may be output through the first user terminal 400. A user may agree to the second terms of use by using a UI 721 displayed on the second terms of use screen 720. Data about the second terms of use agreed by the user may be stored in the server 300.

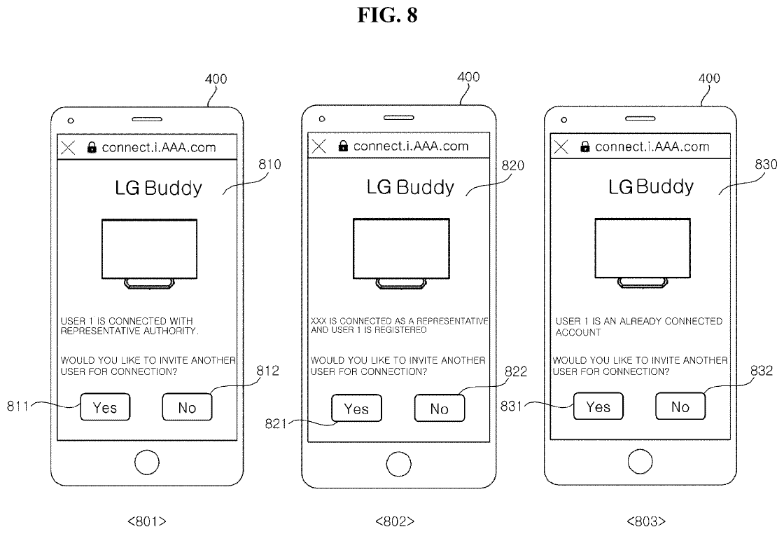

Referring to the reference numeral 801 in FIG. 8, there may be no existing user for whom the control authority over the home appliance 100 is pre-set. In this case, the server 300 may set the control authority over the home appliance 100 for the first user. In addition, as the first user is the only user for whom the control authority over the home appliance 100 is set, the server 300 may determine the first user to be a representative user.

A first settings screen 810 notifying that the control authority is set for the first user may be output through the first user terminal 400. In this case, a message indicating that the first user is determined to be the representative user may be displayed on the first settings screen 810.

In the case where the control authority is set for the first user, since the number of users for whom the control authority is set, including the first user, is one which is less than a maximum number (e.g., five), the server 300 may determine that the control authority may be set for a new user.

If it is possible to set the control authority for a new user, UIs 811 and 812 associated with adding another user, for whom the control authority over the home appliance 100 is set, may be displayed through the first user terminal 400.

Referring to the reference numeral 802 in FIG. 8, the control authority over the home appliance 100 is not pre-set for the first user, there is at least one existing user for whom the control authority over the home appliance 100 is pre-set, and the number of existing users is less than the maximum number (e.g., five). In this case, the server 300 may set the control authority for the first user. A representative user, predetermined by selecting one user from among at least one existing user, may be maintained.

A second settings screen 820 notifying that the control authority is set for the first user may be output through the first user terminal 400. In this case, a message including information about the predetermined representative user may be displayed on the second settings screen 820.

In the case where the control authority is set for the first user, if the number of users for whom the control authority is set, including the first user, is less than a maximum number (e.g., five), the server 300 may determine that the control authority may be set for a new user.

If it is possible to set the control authority for a new user, UIs 821 and 822 associated with adding another user, for whom the control authority over the home appliance 100 is set, may be displayed through the first user terminal 400.

Referring to the reference numeral 803 in FIG. 8, if the control authority over the home appliance 100 is pre-set for the first user, a third settings screen 830 notifying that the control authority over the home appliance 100 is pre-set for the first user may be output through the first user terminal 400.

If the number of users for whom the control authority is set, including the first user, is less than a maximum number (e.g., five), the server 300 may determine that the control authority may be set for a new user.

If it is possible to set the control authority for a new user, UIs 831 and 832 associated with adding another user, for whom the control authority over the home appliance 100 is set, may be displayed through the first user terminal 400.

If the first user selects the UIs 811, 821, and 831 associated with adding another user and displayed on the screens 810, 820, and 830 output through the first user terminal 400, a process of adding another user, for whom the control authority over the home appliance 100 is set, may be performed.

According to an embodiment of the disclosure, if the server 300 sets the control authority for the first user corresponding to the first user terminal 400 that accesses a specific application based on App access information, the server 300 may not limit the control authority set for the first user. For example, the server 300 may not limit the functions of the home appliance 100 that are available to the first user through the first user terminal 400. For example, the server 300 may not limit a time during which the first user is allowed to use the functions of the home appliance 100.

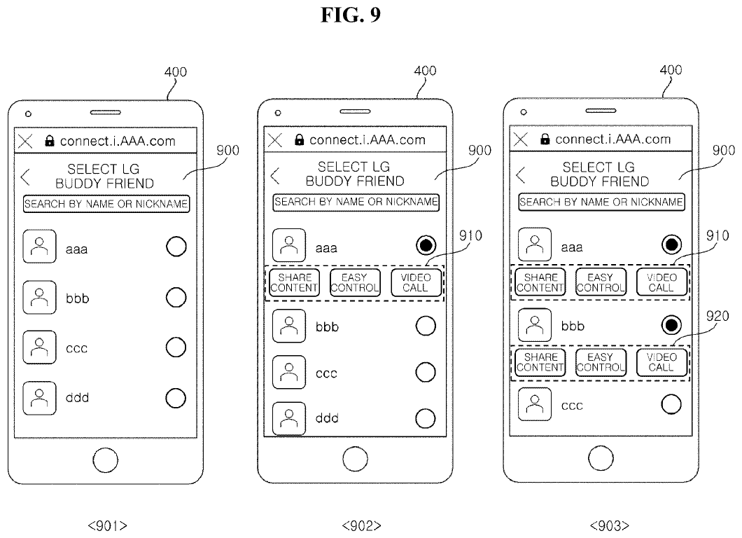

Referring to FIG. 9, a user list screen 900 displaying a user list associated with the first user may be output through the first user terminal 400. The first user may select, as a target user, at least one of users included in the user list by using a UI displayed on the user list screen 900.

As indicated by the reference numeral 901, the process of adding another user may be terminated if a target user is not selected from the user list.

As indicated by the reference numerals 901 and 902, if at least one user is selected as a target user from the user list, UIs 910 and 920 for selecting functions of the home appliance 100 which are available to each of the users selected as the target users may be displayed on the user list screen 900.

The first user terminal 400 may transmit, to the server 300, data about at least one user selected as the target user from the user list by the first user.

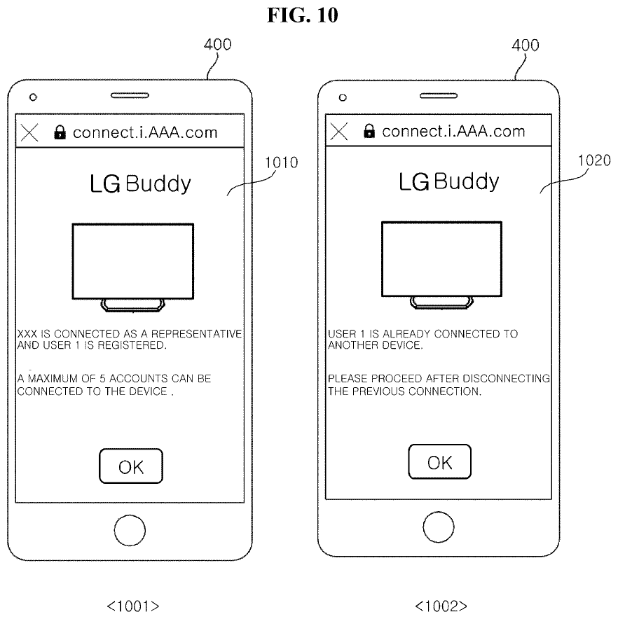

Referring to the reference numeral 1001 in FIG. 10, the control authority over the home appliance 100 is not pre-set for the first user, there is at least one existing user for whom the control authority over the home appliance 100 is pre-set, and the number of existing users is less than the maximum number (e.g., five). In this case, the server 300 may set the control authority for the first user. A representative user, predetermined by selecting one user from among at least one existing user, may be maintained.

In the case where the control authority is set for the first user, if the number of users for whom the control authority is set, including the first user, corresponds to the maximum number (e.g., five), the server 300 may determine that it is impossible to set the control authority for a new user.

A fourth settings screen 1010 notifying that the control authority is set for the first user may be output through the first user terminal 400. In this case, the fourth settings screen 1010 may display a message including information about a predetermined representative user. The fourth settings screen 1010 may display a message indicating that the number of users for whom the control authority is set, including the first user, has reached the maximum number.

If it is impossible to set the control authority for a new user, a UI 1011 associated with ending the process of setting the control authority over the home appliance 100 may be displayed through the first user terminal 400.

Referring to the reference numeral 1002 in FIG. 10, if the control authority over another home appliance 100, which is of the same type as the home appliance 100 corresponding to App access information but is different from the home appliance 100 corresponding to App access information, is pre-set for the first user, the server 300 may determine that it is impossible to set the control authority over the home appliance 100, corresponding to App access information, for the first user.

In this case, a fifth settings screen 1020 may be output, notifying that it is impossible to set the control authority over the home appliance 100, corresponding to App access information, for the first user.

If it is impossible to set the control authority for the first user, a UI 1021 associated with ending the process of setting the control authority over the home appliance 100 may be displayed through the first user terminal 400.

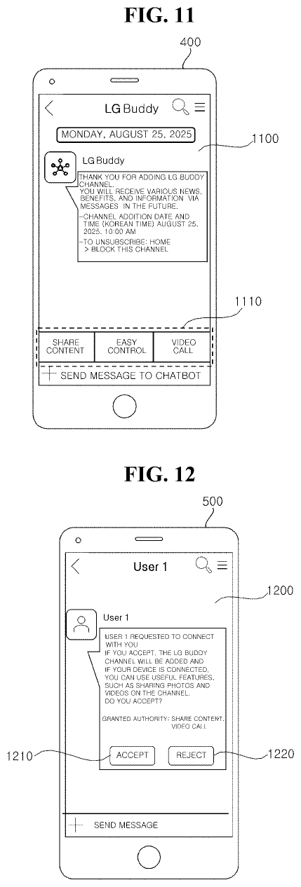

Referring to FIG. 11, the server 300 may transmit a message, corresponding to controlling the home appliance 100, to the first user terminal 400 by using a specific application. For example, if the control authority is set for the first user, the server 300 may transmit the message, corresponding to controlling the home appliance 100, to the first user terminal 400. For example, if the first user agrees to the terms of use of a service that controls the home appliance 100 by using a specific application, the server 300 may transmit the message, corresponding to controlling the home appliance 100, to the first user terminal 400.

The first user terminal 400 may output a screen 1100 corresponding to controlling the home appliance 100. A UI 1110 used for controlling the home appliance 100 may be displayed on the screen 1100.

The first user terminal 400 may transmit a control command corresponding to a user input, received through the UI 1110 used for controlling the home appliance 100, to the server 300. The server 300 may process the control command received from the first user terminal 400.

Referring to FIG. 12, the server 300 may transmit a message, requesting confirmation of granting the control authority, to the second user terminal 400 corresponding to a second user selected as a target user. For example, the server 300 may transmit the message, requesting confirmation of granting the control authority, to the second user terminal 500 through a first user account by using a specific application.

The second user terminal 500 may display the message requesting confirmation of granting the control authority, which is transmitted through the first user account, on a screen 1200 corresponding to the first user. The message requesting confirmation of granting the control authority may include UIs 1210 and 1220 used for confirmation of granting the control authority.

The second user may select to accept or reject control authorization by using the UIs 1210 and 1220 used for confirmation of granting the control authority. The second user terminal 500 may transmit, to the server 300, a control authorization confirmation result corresponding to accepting or rejecting control authorization which is selected by the second user.

According to an embodiment of the disclosure, in response to the second user selecting to reject the control authorization, the server 300 may determine that the process of setting the control authority for the second user is ended.

In response to determination that the process of setting the control authority for the second user is ended, a screen displaying that the process of setting the control authority for the second user is ended may be output through the second user terminal 500. For example, the second user terminal 500 may output, as a web view, the screen displaying that the process of setting the control authority for the second user is ended.

According to an embodiment of the disclosure, when the process of setting the control authority for the second user is ended, if the second user selects the UI 1210 corresponding to accepting the control authorization which is selected by the second user, the screen displaying that the process of setting the control authority for the second user is ended may be output through the second user terminal 500.

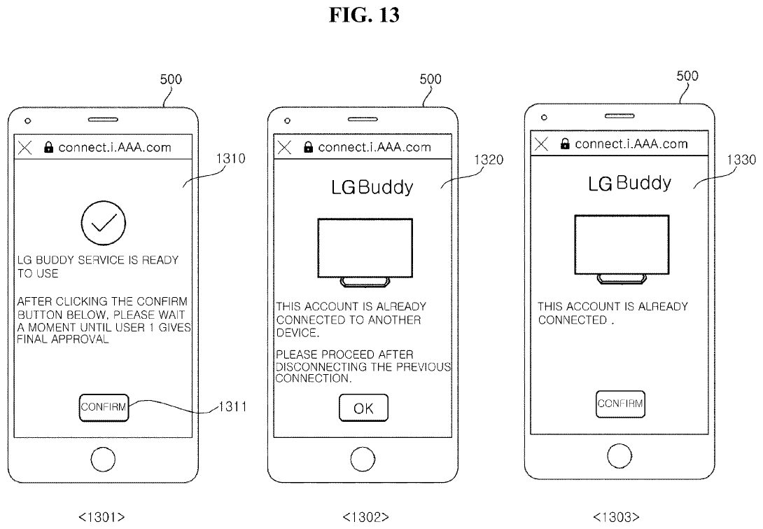

Referring to FIG. 13, in response to the second user selecting to accept the control authorization, the server 300 may determine whether it is possible to set the control authority for the second user.

For example, if the control authority over another home appliance 100, which is of the same type as the home appliance 100 corresponding to App access information but is different from the home appliance 100 corresponding to App access information, is pre-set for the second user, the server 300 may determine that it is impossible to set the control authority over the home appliance 100, corresponding to the App access information, for the second user.

For example, if the control authority over the home appliance 100 is pre-set for the second user, the server 300 may determine that it is impossible to set the control authority for the second user.

According to an embodiment of the disclosure, in response to the second user selecting to accept the control authorization, at least one screen displaying the terms of use of a service that controls the home appliance 100 by using a specific application may be output through the second user terminal 500. The second user may agree to at least one terms of use by using the UI displayed on the screen output by the second user terminal 500. If the second user agrees to the terms of use of the service that controls the home appliance 100 by using the specific application, the server 300 may determine whether it is possible to set the control authority for the second user.

According to an embodiment of the disclosure, in response to the second user selecting to accept the control authorization, the server 300 may determine whether it is impossible to set the control authority over the home appliance 100. In this case, if it is impossible to set the control authority over the home appliance 100, a web view corresponding to the state in which it is impossible to set the control authority over the home appliance 100 may be output through the second user terminal 500.

According to an embodiment of the disclosure, in response to the second user selecting to accept the control authorization, the server 300 may determine whether it is impossible to set the control authority over the home appliance 100 for the second user. In this case, if it is impossible to set the control authority over the home appliance 100 for the second user, a web view corresponding to the state in which it is impossible to set the control authority over the home appliance 100 may be output through the second user terminal 500. For example, if the second user is under an age limit (e.g., 14 years old), the server 300 may control a web view, corresponding to the state in which it is impossible to set the control authority over the home appliance 100, to be output through the second user terminal 500.

According to an embodiment of the disclosure, in response to the second user selecting to accept the control authorization, the server 300 may determine whether it is impossible to set the control authority over the home appliance 100 for a new user. In this case, if it is impossible to set the control authority over the home appliance 100 for the new user, a web view corresponding to the state in which it is impossible to set the control authority over the home appliance 100 may be output through the second user terminal 500. For example, if the number of existing users, for whom the control authority over the home appliance 100 is pre-set, corresponds to a maximum number of users (e.g., five) for whom it is possible to set the control authority over the home appliance 100, the server 300 may control a web view, corresponding to the state in which it is impossible to set the control authority over the home appliance 100, to be output through the second user terminal 500.

Referring to the reference numeral 1301 in FIG. 13, if it is possible to set the control authority for the second user, a screen 1310 that waits for receiving an authorization determination result for the second user may be output through the second user terminal 500. The screen 1310 that waits for receiving the authorization determination result may be output as a web view.

A UI 1311 for confirming that it waits for receiving the authorization determination result may be displayed on the screen 1301 that waits for receiving the authorization determination result for the second user. If a user selects the UI 1311 for confirming that it waits for receiving the authorization determination result, the output of the screen 1310 that waits for receiving the authorization determination result may be terminated. In this case, the screen 1200 corresponding to the first user may be output again through the second user terminal 500.

According to an embodiment of the disclosure, while it waits for receiving the authorization determination result for the second user, if the UIs 1210 and 1220 are selected which are used for confirmation of control authorization and displayed on the screen 1200 corresponding to the first user, the screen that waits for receiving the authorization determination result may be output through the second user terminal 500. The screen that waits for receiving the authorization determination result may be displayed as a web view. The screen that waits for receiving the authorization determination result may be the screen 1310 that waits for receiving the authorization determination result for the second user.

According to an embodiment of the disclosure, while it waits for receiving the authorization determination result for the second user, the server 300 may determine whether it is impossible to set the control authority over the home appliance 100. In this case, if it is impossible to set the control authority over the home appliance 100, a web view may be output which corresponds to the state in which it is impossible to set the control authority over the home appliance 100.

Referring to the reference numeral 1302 in FIG. 13, if the control authority over another home appliance 100, which is of the same type as the home appliance 100 corresponding to App access information but is different from the home appliance 100 corresponding to App access information, is pre-set for the second user, a screen 1320 notifying that it is impossible to set the control authority over the home appliance 100, corresponding to the App access information, for the second user may be output through the second user terminal 500.

Referring to the reference numeral 1303 in FIG. 13, if the control authority over the home appliance 100 is pre-set for the second user, a screen 1330 notifying that the control authority over the home appliance 100 is pre-set for the second user may be output through the second user terminal 500.

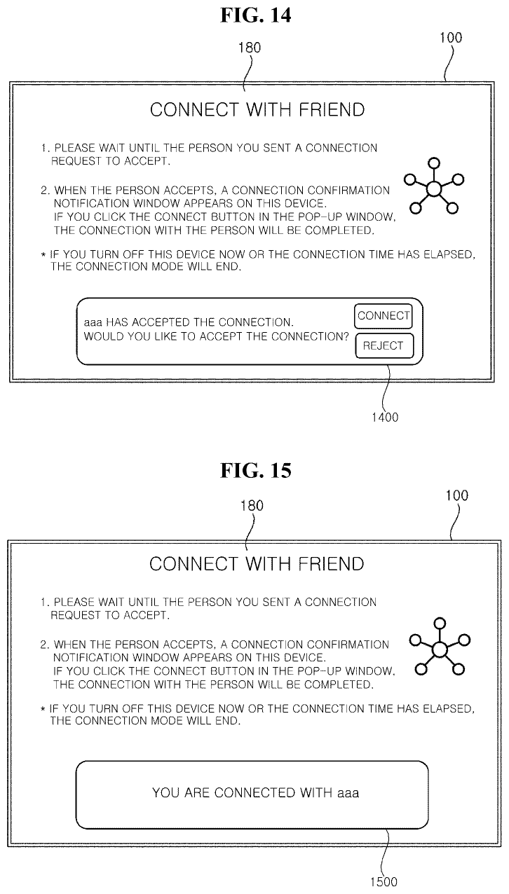

Referring to FIGS. 14 to 16, the home appliance 100 may output a screen that waits for receiving a control authorization confirmation result through the display 180. For example, upon receiving data about a target user from the first user terminal 400, the server 300 may transmit a signal corresponding to selection by the target user to the home appliance 100. In this case, in response to receiving the signal corresponding to selection by the target user, the home appliance 100 may output the screen that waits for receiving the control authorization confirmation result.

Referring to FIG. 14, in response to receiving data corresponding to accepting control authorization for the second user from the server 300, the home appliance 100 may display a UI 1400 associated with control authorization for the second user.

Referring to FIG. 15, in response to approving control authorization for the second user, the home appliance 100 may output a message 1500 corresponding to completing the process of setting the control authority for the second user.

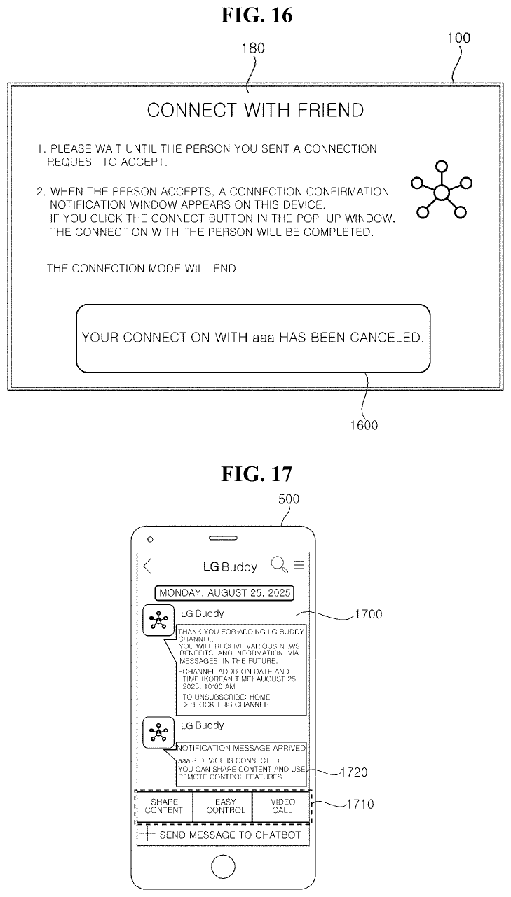

Referring to FIG. 16, in response to denying control authorization for the second user, the home appliance 100 may output a message 1600 corresponding to failure to set the control authority for the second user.

According to an embodiment of the disclosure, if the control authority over another home appliance 100, which is of the same type as the home appliance 100 but is different from the home appliance 100, is set for the second user, the home appliance 100 may output a message 1600 corresponding to failure to set the control authority for the second user.

Referring to FIG. 17, in response to approving control authorization for the second user, the server 300 may transmit a message, indicating that control authorization is approved, to the second user terminal 500 by using a specific application.

The second user terminal 500 may output a screen 1700 corresponding to controlling the home appliance 100.

A UI 1710 used for controlling the home appliance 100 may be displayed on the screen 1700 corresponding to controlling the home appliance 100. A message 1720, indicating that control authorization for the second user is approved, may be displayed on the screen 1700 corresponding to controlling the home appliance 100.

The second user terminal 500 may transmit a control command, corresponding to a user input received through the UI 1710 used for controlling the home appliance 100, to the server 300. The server 300 may process the control command received from the second user terminal 500.

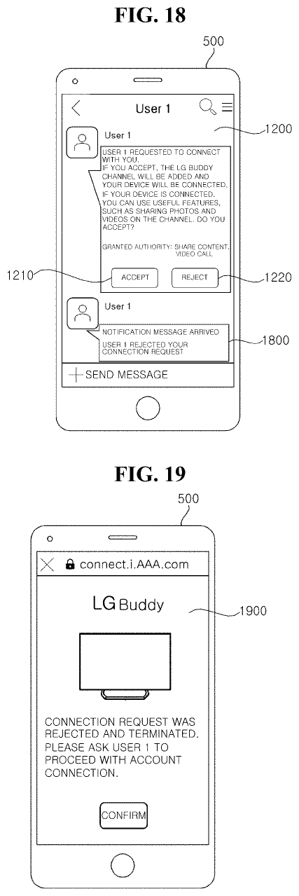

Referring to FIGS. 18 and 19, in response to denying control authorization for the second user, the server 300 may transmit a message, indicating that control authorization is denied, to the second user terminal 500 by using a specific application.

The second user terminal 500 may display a message 1800 indicating that control authorization is denied. For example, the second user terminal 500 may display the message 1800 indicating that control authorization is denied, which is transmitted through the first user account, on the screen 1200 corresponding to the first user.

If the second user selects the UI 1210 corresponding to accepting control authorization when control authorization for the second user is denied, the second user terminal 500 may output a screen 1900 corresponding to failure to set the control authority for the second user. The screen 1900 corresponding to failure to set the control authority for the second user may be output as a web view.

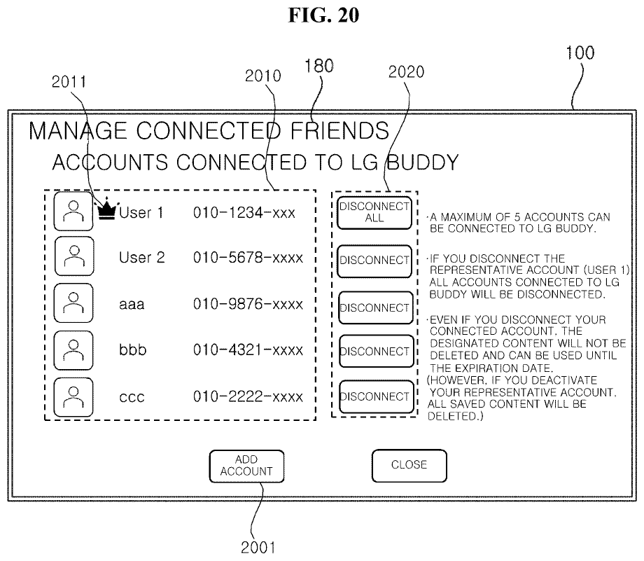

Referring to FIG. 20, the home appliance 100 may output a screen related to management of users, for whom use authority over the home appliance 100 is set, through the display 180.

The screen related to management of users may display user information 2010 of users for whom use authority over the home appliance 100 is set, an object 2011 indicating a representative user, a UI 2020 for releasing use authority of a user, and the like.

A UI 2001 related to adding another user, for whom control authority over the home appliance 100 is set, may be displayed on the screen related to management of users. The home appliance 100 may output the object 510 (see FIG. 5) corresponding to App access information through the display 180 in response to selecting the UI 2001 related to adding another user. The UI 2001 related to adding another user may be deactivated if the number of users, for whom the control authority over the home appliance 100 is set, corresponds to a maximum number (e.g., five).

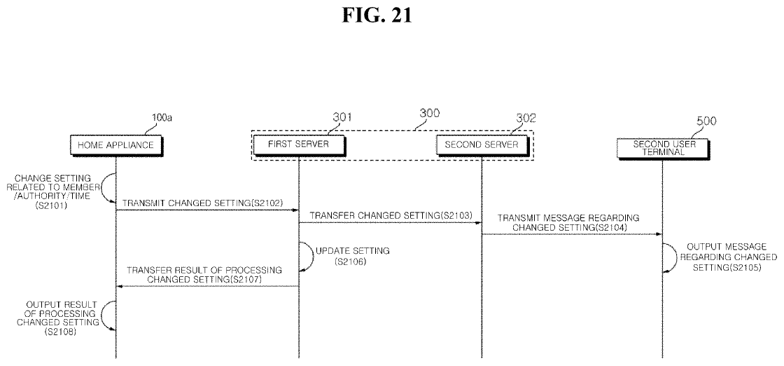

FIG. 21 is a flowchart referred to in the description of operation of a system for changing control authority over a home appliance, according to an embodiment of the present disclosure.

Referring to FIG. 21, the home appliance 100 may change a set control authority over the home appliance 100 in operation S2101. The home appliance 100 may change the pre-set control authority for each user for whom control authority over the home appliance 100 is pre-set.

For example, the home appliance 100 may determine a specific user, for whom the control authority is to be released, among the users for whom the control authority over the home appliance 100 is set. For example, the home appliance 100 may change a function of the home appliance 100 that is available to the specific user for whom the control authority over the home appliance 100 is set, a time during which the specific user is allowed to use the function of the home appliance 100, and the like.

The home appliance 100 may transmit data, corresponding to the changed control authority setting, to the first server 301 in operation S2102. Here, the data corresponding to the changed control authority setting may include a specific user for whom the control authority setting is to be changed, releasing the control authority for the specific user, change of a function of the home appliance 100 that is available to the specific user, change of a time during which the specific user is allowed to use a function of the home appliance 100, and the like.

The first server 301 may transfer the data corresponding to the changed control authority setting, which is received from the home appliance 100, to the second server 302 in operation S2103.

The second server 302 may transmit a message, regarding the changed control authority setting, to the second user terminal 500 corresponding to the second user for whom the control authority setting is to be changed, based on the data corresponding to the changed control authority setting in operation S2104. The second server 302 may transmit the message, regarding the changed control authority setting, to the second user terminal 500 by using a specific application.

For example, if the control authority for the second user is released, the second server 302 may transmit a message, corresponding to releasing the control authority, to the second user terminal 500. For example, in response to a change in function of the home appliance 100 that is available to the second user, the second server 302 may transmit a message, corresponding to the change in function of the home appliance 100, to the second user terminal 500. For example, in response to a change in time during which the second user is allowed to use a function of the home appliance 100, the second server 302 may transmit a message, corresponding to the change in time during which the second user is allowed to use the function of the home appliance 100, to the second user terminal 500.

The second user terminal 500 may output a message corresponding to the changed control authority setting in operation S2105. For example, the second user terminal 500 may output the message corresponding to the changed control authority setting by using a specific application.

The first server 301 may update the setting of the control authority over the home appliance 100 based on the data corresponding to the changed control authority setting in operation S2106.

The first server 301 may transmit, to the home appliance 100, a result of processing the change in setting of the control authority over the home appliance 100 in operation S2107. For example, the first sever 301 may notify the home appliance 100 that update of the setting of the control authority over the home appliance 100 is completed.

The home appliance 100 may output the result of processing the change in setting of the control authority over the home appliance 100 in operation S2108. For example, the home appliance 100 may output a screen corresponding to completing the change of the control authority for a specific user through the display 180.

According to an embodiment of the disclosure, a user determined as a representative user may change the control authority over the home appliance 100 by using a user terminal corresponding to the user determined as the representative user. The user terminal corresponding to the user determined as the representative user may transmit data, corresponding to the changed control authority setting, to the server 300 by using a specific application.

The server 300 may update the setting of the control authority over the home appliance 100 based on the data corresponding to the changed control authority setting, which is received from the user terminal corresponding to the user determined as the representative user.

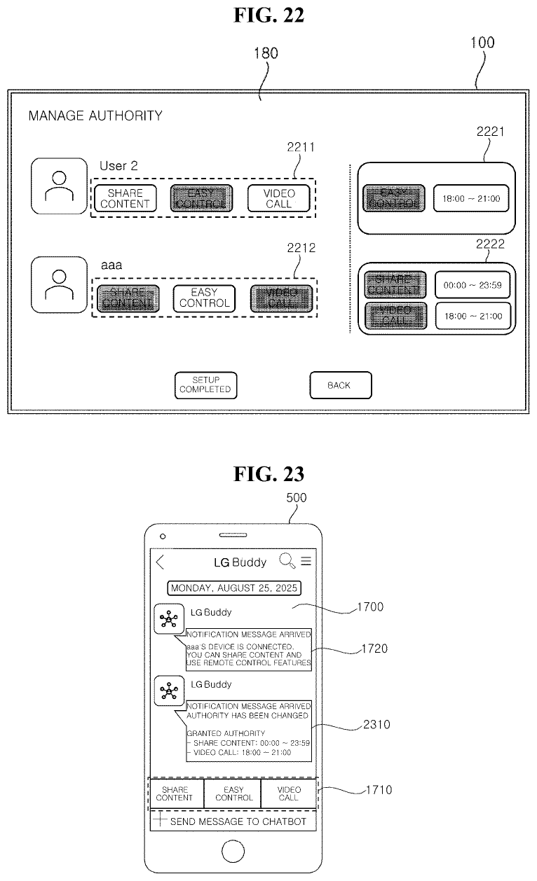

FIGS. 22 and 23 are diagrams referred to in the description of a change in control authority over a home appliance, according to an embodiment of the present disclosure.

Referring to FIG. 22, the home appliance 100 may output a screen related to control authority management through the display 180.

The screen related to control authority management may display UIs 2211 and 2212 related to setting functions of the home appliance 100 that are available to each user for whom the control authority is set, UIs 2221 and 2222 related to setting a time during which each user is allowed to use the functions of the home appliance 100, and the like.

Referring to FIG. 23, the second user terminal 500 may output a message 2310 corresponding to the changed control authority setting. For example, a message 2310 corresponding to the changed control authority setting may be displayed on the screen 1700 corresponding to controlling the home appliance 100.

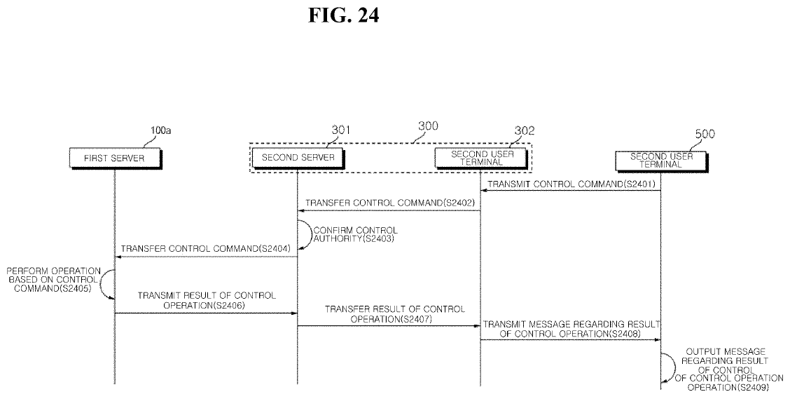

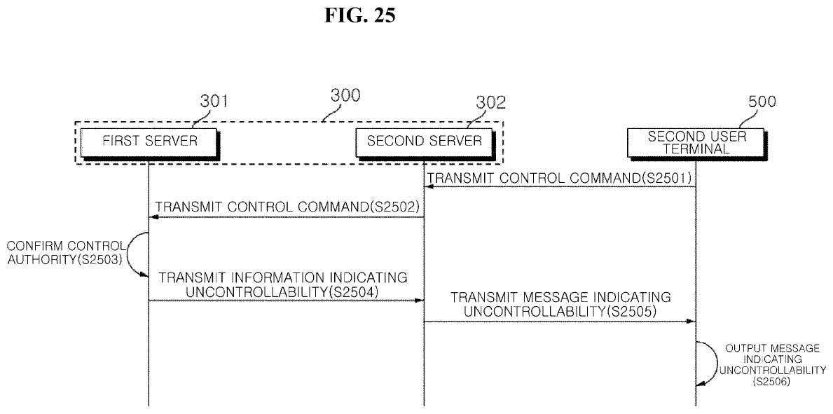

FIGS. 24 and 25 are flowcharts referred to in the description of operation of a system for controlling a home appliance, according to an embodiment of the present disclosure.

Referring to FIG. 24, the second user terminal 500 may transmit a control command to the second server 302 in operation S2401. The second user terminal 500 may transmit the control command to the second server 302 by using a specific application.

The second server 302 may transfer the control command, received from the second user terminal 500, to the first server 301. The second server 302 may transmit, along with the control command, information about the second user corresponding to the second user terminal 500 and/or information about the home appliance which is to be controlled to the first server 301 in operation S2402.

The first server 301 may confirm the control authority set for the second user in operation S2403.

For example, the first server 301 may determine whether the control authority over the home appliance 100 is set for the second user. For example, the first server 301 may determine whether the second user is allowed to use a function of the home appliance 100 that corresponds to the control command. For example, the first server 301 may determine whether a current time when the control command is processed falls within a time range during which the second user is allowed to use the function of the home appliance 100 that corresponds to the control command.

The first server 301 may transfer the control command to the home appliance 100 in operation S2404. For example, in the case where the control authority over the home appliance 100 is pre-set for the second user, the function of the home appliance 100 that corresponds to the control command is a function that is available to the second user, and the current time when the control command is processed falls within the time range during which the second user is allowed to use the function of the home appliance 100 that corresponds to the control command, the first server 301 may transfer the control command to the home appliance 100.

The home appliance 100 may perform an operation based on the control command, transferred from the server 301, in operation S2405.

The home appliance 100 may transmit a result of performing the operation based on the control command to the first server 301 in operation S2406.

The first server 301 may transfer the result of performing the operation based on the control command, received from the home appliance 100, to the second server 302 in operation S2407.

The second server 302 may transmit a message, regarding the result of the operation performed by the home appliance 100 based on the control command, to the second user terminal 500 in operation S2408. For example, the second server 302 may transmit the message, regarding the result of the operation performed by the home appliance 100 based on the control command, to the second user terminal 500 by using a specific application.

The second user terminal 500 may output the message regarding the result of the operation performed by the home appliance 100 based on the control command in operation S2409. For example, the second user terminal 500 may output the message, regarding the result of the operation performed by the home appliance 100 based on the control command, by using a specific application.

Referring to FIG. 25, the second user terminal 500 may transmit the control command to the second server 302 in operation S2501. The second user terminal 500 may transmit the control command to the second server 302 by using a specific application.

The second server 302 may transfer the control command, received from the second server 302, to the first server 301 in operation S2502. The second server 302 may transmit, along with the control command, information about the second user corresponding to the second user terminal 500 and/or information about the home appliance 100 which is to be controlled to the first server 301.

The first server 301 may confirm control authority set for the second user in operation S2503.

The first server 301 may transmit information, indicating that the home appliance 100 is uncontrollable based on the control command, to the second server 302 in S2504.

For example, if control authority over the home appliance 100 is not set for the second user, the first server 301 may transmit, to the second server 302, a message indicating that the home appliance 100 is uncontrollable based on the control command. For example, if the function of the home appliance 100 that corresponds to the control command is a function that is not available to the second user, the first server 301 may transmit a message, indicating that the home appliance 100 is uncontrollable based on the control command, to the second server 302. For example, if a current time when the control command is processed falls outside a time range during which the second user is allowed to use the function of the home appliance 100 that corresponds to the control command, the first server 301 may transmit, to the second server 302, a message indicating that the home appliance 100 is uncontrollable based on the control command.

The second server 302 may transmit a message, indicating that the home appliance 100 is uncontrollable based on the control command, to the second user terminal 500 in operation S2505. For example, the second server 302 may transmit the message, indicating that the home appliance 100 is uncontrollable based on the control command, to the second user terminal 500 by using a specific application.

The second user terminal 500 may output the message indicating that the home appliance 100 is uncontrollable based on the control command in operation S2506. For example, the second user terminal 500 may output the message, indicating that the home appliance 100 is uncontrollable based on the control command, by using a specific application.

As described above, according to at least one of the embodiments of the present disclosure, the control authority over the home appliance 100 may be set for at least one user in a simple and convenient manner.

In addition, according to at least one of the embodiments of the present disclosure, the control authority over the home appliance 100 may be set individually for each user.

In addition, according to at least one of the embodiments of the present disclosure, it is possible to set various functions of the home appliance 100 that are available to users.

In addition, according to at least one of the embodiments of the present disclosure, it is possible to set various times during which users are allowed to use functions of the home appliance 100.

In addition, according to at least one of the embodiments of the present disclosure, a service associated with controlling the home appliance 100 may be provided by using a specific application corresponding to a service for supporting communication between users.

Referring to FIGS. 1 to 25, a system 10 according to an embodiment of the present disclosure includes a home appliance 100, a plurality of user terminals 400 and 500, and at least one server 300, wherein a first user terminal 400 is configured to obtain a user list corresponding to a specific application from the at least one server 300 and to transmit data about a user selected from the user list to the at least one server 300, wherein the at least one server 300 is configured to set control authority over the home appliance 100 for the selected user based on the data about the selected user which is received from the first user terminal 400 and to process a control command received from a second user terminal 500, corresponding to the selected user, by using the specific application based on the control authority set for the selected user.

In addition, according to an embodiment of the present disclosure, the at least one server 300 may include: a first server 301 corresponding to the home appliance 100, and configured to set the control authority for the selected user and to process the control command; and a second server 302 corresponding to the specific application, and configured to provide the user list to the first user terminal 400 and to transfer the control command, received using the specific application, to the first server 301.

In addition, according to an embodiment of the present disclosure, the home appliance 100 is configured to transmit a request for transmitting specific data for access to the specific application, which includes an identifier of the home appliance 100, to the at least one server 300, and to output a specific object corresponding to the specific data through a display 180 of the home appliance 100 based on receiving the specific data from the at least one server 300, wherein the at least one server 300 is configured to transmit the specific data corresponding to the identifier of the home appliance 100 to the home appliance 100.

In addition, according to an embodiment of the present disclosure, the specific data may include an effective time during which access to the specific application is allowed, wherein the home appliance 100 is configured to output the effective time along with the specific object through the display 180.

In addition, according to an embodiment of the present disclosure, the object may be an image corresponding to a deep link to a web view which is configured to access the specific application to obtain the user list and to transmit the data about the selected user to the at least one server 300.

In addition, according to an embodiment of the present disclosure, in response to receiving data about the selected user from the first user terminal 400, the at least one server 300 is configured to transmit a message, requesting confirmation of granting the control authority, to the second user terminal 500 by using the specific application, and configured to set the control authority for the selected user based on a result of the confirmation of granting the control authority, which is received from the second user terminal 500, by using the specific application.

In addition, according to an embodiment of the present disclosure, the data about the selected user may include: a user account corresponding to the selected user used in the specific application; and at least one function of the home appliance 100 used by the selected user.

In addition, according to an embodiment of the present disclosure, the at least one server 300 is configured to, in response to receiving a command for setting the control authority for the selected user from at least one of the home appliance 100 and the first user terminal 400, reset the control authority, which is set for the selected user, based on the command for setting the control authority, and to transmit a message, notifying that the control authority is reset, to the second user terminal 500 by using the specific application.

In addition, according to an embodiment of the present disclosure, the control authority may include: a first authority corresponding to at least one function of the home appliance 100 which is used by the selected user; and a second authority corresponding to a time during which the selected user is allowed to use each of the at least one function.

In addition, according to an embodiment of the present disclosure, the at least one server 300 is configured to determine, as a representative user, one user among the at least one user for whom the control authority over the home appliance 100 is set, and in response to the control authority set for the representative user being released, is configured to release the control authority for all of the at least one user.

A method of operating a system 10 including at least one server 300 according to an embodiment of the present disclosure includes: by the at least one server 300, providing a user list corresponding to a specific application to a home appliance 100; by the at least one server 300, receiving, from the home appliance 100, data about a user selected from the user list; by the at least one server 300, setting control authority over the home appliance 100 for the selected user based on the data about the selected user which is received from a first user terminal 400; and by the at least one server 300, processing a control command received from a second user terminal 500, corresponding to the selected user, by using the specific application based on the control authority set for the selected user.

In addition, according to an embodiment of the present disclosure, the at least one server 300 may include: a first server 301 corresponding to the home appliance 100, and configured to set the control authority for the selected user and to process the control command; and a second server 302 corresponding to the specific application, and configured to provide the user list to the first user terminal 400 and to transfer the control command, received using the specific application, to the first server 301.

In addition, according to an embodiment of the present disclosure, the method may further include: by the at least one server 300, receiving, from the home appliance 100, a request for transmitting specific data for access to the specific application that includes an identifier of the home appliance 100; and by the at least one server, transmitting, to the home appliance 100, the specific data corresponding to the identifier of the home appliance 100, wherein the specific data may correspond to a specific object output through a display 180 of the home appliance 100.

In addition, according to an embodiment of the present disclosure, the specific data may include an effective time during which access to the specific application is allowed, the specific application output along with the specific object through the display 180 of the home appliance 100.

In addition, according to an embodiment of the present disclosure, the object may be an image corresponding to a deep link to a web view which is configured to access the specific application to obtain the user list and to transmit the data about the selected user to the at least one server 300.

In addition, according to an embodiment of the present disclosure, the setting of the control authority may include: by the at least one server 300, in response to receiving data about the selected user from the first user terminal 400, transmitting, to the second user terminal 500, a message requesting confirmation of granting the control authority by using the specific application; and by the at least one server 300, setting the control authority for the selected user based on a result of the confirmation of granting the control authority, which is received from the second user terminal 500, by using the specific application.

In addition, according to an embodiment of the present disclosure, the data about the selected user may include: a user account corresponding to the selected user used in the specific application; and at least one function of the home appliance 100 which is used by the selected user.

In addition, according to an embodiment of the present disclosure, the method may further include, in response to receiving a command for setting the control authority for the selected user from at least one of the home appliance 100 and the first user terminal 400, resetting, by the at least one server 300, the control authority which is set for the selected user, based on the command for setting the control authority; and by the at least one server 300, transmitting a message, notifying that the control authority is reset, to the second user terminal 500 by using the specific application.

In addition, according to an embodiment of the present disclosure, the control authority may include: a first authority corresponding to at least one function of the home appliance 100 which is used by the selected user; and a second authority corresponding to a time during which the selected user is allowed to use each of the at least one function.

In addition, according to an embodiment of the present disclosure, the method may further include: by the at least one server 300, determining, as a representative user, one user among at least one user for whom the control authority over the home appliance 100 is set; and in response to the control authority set for the representative user being released, releasing, by the at least one server 300, the control authority for all of the at least one user.

What is claimed is:

1. A system comprising a home appliance, a plurality of user terminals, and at least one server,
wherein a first user terminal is configured to:
obtain a user list corresponding to a specific application from the at least one server, and
transmit data about a user selected from the user list to the at least one server,
wherein the at least one server is configured to:
set control authority over the home appliance for the selected user based on the data about the selected user which is received from the first user terminal, and
process a control command received from a second user terminal, corresponding to the selected user, by using the specific application based on the control authority set for the selected user.

2. The system of claim 1, wherein the at least one server comprises:
a first server corresponding to the home appliance, and configured to set the control authority for the selected user and to process the control command; and
a second server corresponding to the specific application, and configured to provide the user list to the first user terminal and to transfer the control command, received using the specific application, to the first server.

3. The system of claim 1, wherein the home appliance is configured to:
transmit a request for transmitting specific data for access to the specific application, which includes an identifier of the home appliance, to the at least one server, and
output a specific object corresponding to the specific data through a display of the home appliance based on receiving the specific data from the at least one server,
wherein the at least one server is configured to transmit the specific data corresponding to the identifier of the home appliance to the home appliance.

4. The system of claim 3, wherein the specific data comprises an effective time during which access to the specific application is allowed,
wherein the home appliance is configured to output the effective time along with the specific object through the display.

5. The system of claim 3, wherein the object is an image corresponding to a deep link to a web view which is configured to access the specific application to obtain the user list and to transmit the data about the selected user to the at least one server.

6. The system of claim 1, wherein in response to receiving data about the selected user from the first user terminal, the at least one server is configured to:
transmit a message, requesting confirmation of granting the control authority, to the second user terminal by using the specific application, and
set the control authority for the selected user based on a result of the confirmation of granting the control authority, which is received from the second user terminal by using the specific application.

7. The system of claim 1, wherein the data about the selected user comprises:
a user account corresponding to the selected user used in the specific application; and
at least one function of the home appliance which is used by the selected user.

8. The system of claim 1, wherein the at least one server is configured to:
in response to receiving a command for setting the control authority for the selected user from at least one of the home appliance and the first user terminal, reset the control authority, which is set for the selected user, based on the command for setting the control authority, and
transmit a message, notifying that the control authority is reset, to the second user terminal by using the specific application.

9. The system of claim 1, wherein the control authority comprises:
a first authority corresponding to at least one function of the home appliance which is used by the selected user; and
a second authority corresponding to a time during which the selected user is allowed to use each of the at least one function.

10. The system of claim 1, wherein the at least one server is configured to:
determine, as a representative user, one user among at least one user for whom the control authority over the home appliance is set, and
in response to the control authority set for the representative user being released, release the control authority for all of the at least one user.

11. A method of operating a system including at least one server, the method comprising:
by the at least one server, providing a user list corresponding to a specific application to a home appliance;
by the at least one server, receiving, from the home appliance, data about a user selected from the user list;
by the at least one server, setting control authority over the home appliance for the selected user based on the data about the selected user which is received from a first user terminal; and
by the at least one server, processing a control command received from a second user terminal, corresponding to the selected user, by using the specific application based on the control authority set for the selected user.

12. The method of claim 11, wherein the at least one server comprises:
a first server corresponding to the home appliance, and configured to set the control authority for the selected user and to process the control command; and
a second server corresponding to the specific application, and configured to provide the user list to the first user terminal and to transfer the control command, received using the specific application, to the first server.

13. The method of claim 11, further comprising:
by the at least one server, receiving, from the home appliance, a request for transmitting specific data for access to the specific application that includes an identifier of the home appliance; and
by the at least one server, transmitting, to the home appliance, the specific data corresponding to the identifier of the home appliance,
wherein the specific data corresponds to a specific object output through a display of the home appliance.

14. The method of claim 13, wherein the specific data comprises an effective time during which access to the specific application is allowed, the specific application output along with the specific object through the display of the home appliance.

15. The method of claim 13, wherein the object is an image corresponding to a deep link to a web view which is configured to access the specific application to obtain the user list and to transmit the data about the selected user to the at least one server.

16. The method of claim 11, wherein the setting of the control authority comprises:
by the at least one server, in response to receiving data about the selected user from the first user terminal, transmitting, to the second user terminal, a message requesting confirmation of granting the control authority by using the specific application; and
by the at least one server, setting the control authority for the selected user based on a result of the confirmation of granting the control authority, which is received from the second user terminal, by using the specific application.

17. The method of claim 11, wherein the data about the selected user comprises:
a user account corresponding to the selected user used in the specific application; and
at least one function of the home appliance which is used by the selected user.

18. The method of claim 11, further comprising:
in response to receiving a command for setting the control authority for the selected user from at least one of the home appliance and the first user terminal, resetting, by the at least one server, the control authority which is set for the selected user, based on the command for setting the control authority; and
by the at least one server, transmitting a message, notifying that the control authority is reset, to the second user terminal by using the specific application.

19. The method of claim 11, wherein the control authority comprises:
a first authority corresponding to at least one function of the home appliance which is used by the selected user; and
a second authority corresponding to a time during which the selected user is allowed to use each of the at least one function.

20. The method of claim 11, further comprising:
by the at least one server, determining, as a representative user, one user among at least one user for whom the control authority over the home appliance is set; and
in response to the control authority set for the representative user being released, releasing, by the at least one server, the control authority for all of the at least one user.
